(19) United States
(12) Patent Application Publication
(10) Pub. No.: US 2006/0257673 A1
(43) Pub. Date: Nov. 16, 2006

(54) Laminates, their production and use

(75) Inventors: Ulrich Desor, Idstein (DE); Werner Prass, Mainz (DE); Josef Reitspiess, Frankfurt (DE)

Correspondence Address: CONNOLLY BOVE LODGE & HUTZ, LLP, P O BOX 2207, WILMINGTON, DE, 19899, US

(73) Assignee: Celanese Emulsions GmbH, Kronberg/Ts. (DE)

(21) Appl. No.: 11/433,860

(22) Filed: May 13, 2006

(30) Foreign Application Priority Data
May 13, 2005 (DE) 10 2005 022 166.1

(51) Int. Cl. B32B 9/04

(52) U.S. Cl. 428/448

(57) ABSTRACT

A description is given of laminates comprising sheetlike substrate and film joined to the substrate by means of an adhesive which comprises a polymer dispersion prepared by free-radical emulsion polymerization and an organosilane which is incorporated into the polymer during the polymerization and/or is added subsequently and which in addition to at least one silane group has at least one primary, secondary or tertiary amino group or at least one epoxide group or which comprises at least one ethylenically unsaturated group and at least one silane group. Through the addition of an organosilane it is possible to produce laminates which can be processed rapidly and which are distinguished by improved embossing strength.

The present invention relates to laminates produced by bonding with selected polymer dispersions.

The use of aqueous polymer dispersions as adhesives or as binders in aqueous adhesive preparations is known to the skilled worker. In comparison with solventborne adhesives these polymer dispersions offer the advantage of allowing the emission of solvents to be avoided when they are used. Since organic solvents are usually flammable or even readily ignitable, aqueous adhesives of this kind also offer a distinct safety advantage in use.

Adhesives comprising polymer dispersions and organosilane additions are already known. EP-A-215,518 describes an aqueous polymer dispersion comprising an aminosilane. The dispersion is used as a building adhesive or paint with improved wet strength. JP-A-10/178,931 describes emulsion paints comprising epoxysilane compounds. The coatings produced using these paints exhibit high weathering, chemical, and water resistance. US-A-2002/0037964 describes a reaction product of polyisocyanates with selected aminosilanes. It can be used as an adhesion promoter in primers. U.S. Pat. No. 4,032,487 discloses an adhesive composition comprising a selected acrylate copolymer and a crosslinker containing epoxide and alkoxysilane functionalities. US-A-2005/0038152 describes a pressure-sensitive adhesive based on an aqueous dispersion which comprises a silane-modified polyacrylate and a compound which couples with the silane. This adhesive is easily detached from the temporary backing film. JP-A-2002/241,725 describes an aqueous dispersion comprising a silane-modified polyacrylate and finely divided filler attached thereto. The dispersion can be used as a pressure-sensitive adhesive. JP-A-2003/321,660 discloses a further pressure-sensitive adhesive which comprises an aqueous dispersion comprising a silane-modified polyacrylate and also an aminosilane.

Additionally, laminates have already been described that have been produced using adhesives comprising polymeric components and organosilane additions. US-A-2004/0092689 describes a selected acrylic resin which preferably comprises a silane and is used to produce laminates for optical applications, such as for producing LCDs. EP-A-1,283,232 discloses a two-part adhesive for producing laminates that comprises a hardener component, comprising polyisocyanate and silane coupler, and a base component, comprising polyol. JP-A-11/245,346 discloses a laminated film for packaging. This film is composed of two films having nonabsorbent surfaces, namely a polyvinylidene film laminated to a support film. The adhesive used is an aqueous dispersion of a polyester-polyurethane resin to which a silane adhesion promoter has been added. JP-A-09/125,039 discloses an adhesive for wood-metal laminates. This adhesive comprises a water-soluble polymer or an aqueous polymer dispersion, a filler, an isocyanate crosslinker, and a silane coupling agent. The wood-metal laminates described are not embossable.

DE 198 38 667 A1 discloses the use of selected aqueous polyacrylate dispersions as laminating adhesives. During the preparation of the dispersions it is possible to use regulators. Among the examples given of regulators is mercaptopropyltrimethoxysilane.

For the production of laminates a multiplicity of different requirements are imposed on the laminating adhesive. For instance, it is desired that the laminating adhesives should be suitable for bonding different materials, such as polymer films, metal foils or metallized polymer films, to paper and to coated paper and cardboard. The laminating adhesives ought to adhere well to all these substrates and ought to produce high and lasting strength in the assembly as short a time as possible after lamination. The adhesives are also expected to display trouble-free processing even on high-speed machinery, which means that even the dispersion used as binder must already display high shear stability and good flow properties.

In the special case of high gloss film lamination a transparent polymer film is first coated with the liquid adhesive. The adhesive is dried and then the adhesive-coated film is laminated under heat and pressure to the substrate, usually a printed paper or a printed cardboard. The laminate thus produced is frequently processed further a relatively short time after lamination, and is embossed, folded or grooved. The deformation of the laminate that this entails must not be accompanied by any instances whatsoever of detachment of the film from the substrate. In order to prevent such instances of detachment, the adhesive layer is generally crosslinked. This can take place by incorporation of a chemical crosslinking system into the dispersion, as described in EP-A-148,386 or EP-A-644,902, or by addition of water-soluble isocyanate hardeners or else by incorporation of UV-crosslinking groups, as described in DE-A-101 35 379.

In view of the fact that chemically crosslinking adhesives need time to cure it is necessary with these systems to wait for a certain storage period before the laminated systems can be processed further. This disadvantage may be alleviated by using UV-curing adhesives. These systems, however, necessitate an additional irradiating station in the laminating plant, and there are restrictions in terms of the films which can be used, since matt films or films which are not transparent to UV light cannot be used.

On the basis of this prior art the object of the invention was to provide a laminate which without incorporation of additional equipment into the laminating plant has an enhanced embossing strength a short time after lamination without detriment to the other properties of the laminate.

It has now been found that adhesives comprising aqueous polymer dispersions can be used, through the addition of organosilanes, to produce laminated assemblies which exhibit improved embossability.

The present invention provides embossable laminates comprising
a) a sheetlike substrate having at least one absorbent surface,
b) a film which
c) is joined to the substrate by means of an adhesive which comprises a polymer dispersion prepared by free-radical emulsion polymerization and an organosilane which is incorporated into the polymer during the polymerization and/or is added subsequently and which in addition to at least one silane group has at least one primary, secondary or tertiary amino group or at least one epoxide group or which comprises at least one ethylenically unsaturated group and at least one silane group.

The laminates of the invention must be embossable—that is, they must be capable of patterning by means of appropriate pressure treatment of selected parts of the surface. The laminates of the invention need not necessarily have been patterned by embossing. With preference, however, these laminates do have at least one embossed surface.

The laminates of the invention are produced using sheetlike substrates having at least one absorbent surface. In the context of this description these substrates are flexible and rigid substrates which are composed of paper, cardboard or else other fiber materials, examples being webs of glass, polymeric fibers or natural fibers. The substrates may be composed of one or more materials or else may themselves be laminates, such as polymeric laminates having at least one absorbent surface, which if desired may also carry printed circuits.

Particular preference is given to using substrates which are sheetlike and at the same time flexible and have absorbent surfaces. Examples of such substrates are papers, including card and cardboard, and other fiber webs. These materials may also be printed and/or coated.

To produce the laminates of the invention it is possible to use any desired films.

Like the substrates, these films may be composed of any of a very wide variety of materials, such as of plastics, metals, veneer or paper, for example.

Films of metals (foils) or of polymers are preferred, especially transparent polymeric films.

Examples of metal foils used with preference are aluminum foils.

Examples of polymeric films used with preference are films of polyethylene (PE), polypropylene (PP), especially of oriented polypropylene (OPP), polystyrene (PS), cellulose acetate (CA), polyvinyl chloride (PVC), polyamide (PA), and polyethylene terephthalate (PET).

Examples of transparent polymeric films employed with particular preference are films of oriented (monoaxially or biaxially oriented) polypropylene or of cellulose acetate.

Particular preference is given to laminates wherein the substrate surface is printed and the polymeric film is transparent.

Another preferred laminate has embossing on the film side.

The adhesives used in accordance with the invention comprise polymer dispersions prepared by free-radical emulsion polymerization of ethylenically unsaturated monomers. Adhesives of this kind are known per se.

The selection of ethylenically unsaturated monomers suitable for preparing the polymer dispersions is not critical per se. All monomers commonly used for preparing polymer dispersions are suitable that can be rationally combined with one another in accordance with the requirements of the art.

Preferred principal monomers are vinyl esters of carboxylic acids having 1 to 18 carbon atoms, full esters or monoesters of ethylenically unsaturated C₃-C₈ monocarboxylic and dicarboxylic acids with C₁-C₁₈ alkanols, and aromatic or aliphatic, ethylenically unsaturated, optionally halogen-substituted hydrocarbons.

As vinyl esters of carboxylic acids having 1 to 18 carbon atoms it is possible to use all of the monomers that are known to the skilled worker. Particular preference, however, is given to vinyl esters of carboxylic acids having 1 to 4 carbon atoms, such as vinyl formate, vinyl acetate, vinyl propionate, vinyl isobutyrate, vinyl pivalate, and vinyl 2-ethylhexanoate; vinyl esters of saturated, branched monocarboxylic acids having 9, 10 or 11 carbon atoms in the acid radical (®Versatic acids); vinyl esters of longer-chain saturated and unsaturated fatty acids, such as vinyl esters of fatty acids having 8 to 18 carbon atoms, such as vinyl laurate and vinyl stearate; vinyl esters of benzoic acid or of p-tert-butylbenzoic acid, and also mixtures thereof, such as mixtures of vinyl acetate and a Versatic acid or of vinyl acetate and vinyl laurate, for example. Vinyl acetate is especially preferred.

As full esters or monoesters of ethylenically unsaturated C₃-C₈ monocarboxylic and dicarboxylic acids with C₁-C₁₈ alkanols it is possible to use all of the monomers that are known to the skilled worker. Preference is given here to the full esters and monoesters of ethylenically unsaturated C₃-C₈ monocarboxylic and dicarboxylic acids with C₁-C₁₂ alkanols, and C₁-C₈ alkanols or C₅-C₈ cycloalkanols are particularly preferred. Examples of suitable C₁-C₁₈ alkanols are methanol, ethanol, n-propanol, isopropanol, 1-butanol, 2-butanol, isobutanol, tert-butanol, n-hexanol, 2-ethylhexanol, lauryl alcohol, and stearyl alcohol. Examples of suitable cycloalkanols are cyclopentanol and cyclohexanol.

Particular preference is given to the esters of acrylic acid, of methacrylic acid, of crotonic acid, of maleic acid, of itaconic acid, of citraconic acid, and of fumaric acid. Especial preference is given to the esters of acrylic acid and/or of methacrylic acid, such as methyl (meth)acrylate, ethyl (meth)acrylate, isopropyl (meth)acrylate, n-butyl (meth)acrylate, isobutyl (meth)acrylate, 1-hexyl (meth)acrylate, tert-butyl (meth)acrylate, 2-ethylhexyl (meth)acrylate, and also the esters of fumaric acid and of maleic acid, such as dimethyl fumarate, dimethyl maleate, di-n-butyl maleate, di-n-octyl maleate, and di-2-ethylhexyl maleate. Where appropriate the stated esters may also be substituted by epoxy and/or hydroxyl groups.

Examples of aromatic or aliphatic, ethylenically unsaturated, optionally halogen-substituted hydrocarbons are ethene, propene, 1-butene, 2-butene, isobutene, styrene, vinyltoluene, vinyl chloride, and vinylidene chloride, preference being given to ethene and styrene.

Besides these principal monomers it is possible to use functional monomers. These include ionic monomers and nonionic monomers having functional groups.

The ionic monomers include those compounds which carry at least one carboxylic, sulfonic, phosphoric or phosphonic acid group in direct vicinity to the double-bond unit or else are attached to said unit via a spacer. Examples that may be mentioned include the following: ethylenically unsaturted C₃-C₈ monocarboxylic acids, ethylenically unsaturated C₅-C₈ dicarboxylic acids and their anhydrides, and monoesters of ethylenically unsaturated C₄-C₈ dicarboxylic acids.

Preference is given to unsaturated monocarboxylic acids, such as acrylic acid and methacrylic acid and also their anhydrides; unsaturated dicarboxylic acids, such as maleic acid, fumaric acid, itaconic acid, and citraconic acid, and also their monoesters with C₁-C₁₂ alkanols, such as monomethyl maleate and mono-n-butyl maleate, for example. Other preferred, ethylenically unsaturated, ionic monomers are ethylenically unsaturated sulfonic acids such as vinylsulfonic acid, 2-acrylamido-2-methylpropanesulfonic acid, 2-acryloyloxyethanesulfonic acid and 2-methacryloyloxyethanesulfonic acid, 3-acryloyloxy- and 3-methacryloyloxy-propanesulfonic acid, vinylbenzenesulfonic acid, and ethylenically unsaturated phosphonic acids, such as vinylphosphonic acid.

Additionally, as well as the stated acids, it is also possible to use their salts, preferably their alkali metal or ammonium salts, and more preferably their sodium salts, such as the sodium salts of vinylsulfonic acid and of 2-acrylamidopropanesulfonic acid, for example.

Further suitable ethylenically unsaturated, ionic monomers include monomers with cationic functionality, such as monomers which are based, for example, on quaternary ammonium groups. Anionic monomers, however, are preferred.

The ethylenically unsaturated, nonionic functional monomers include, for example, the amides of the carboxylic acids specified in connection with the ethylenically unsaturated ionic monomers, such as, for example, methacrylamide and acrylamide, and also water-soluble N-vinyl lactams, such as N-vinylpyrrolidone, for example, and also compounds containing covalently bonded polyethylene glycol units as ethylenically unsaturated compounds, such as polyethylene glycol monoallyl or diallyl ethers or the esters of ethylenically unsaturated carboxylic acids with polyalkylene glycols, for example.

Additionally, further ethylenically unsaturated, non ionic functional monomers that are suitable are nitriles of ethylenically unsaturated C₃-C₈ carboxylic acids, such as acrylonitrile and methacrylonitrile, and also adhesion-promoting and crosslinking monomers. It is possible as well to use C₄-C₈ conjugated dienes, such as 1,3-butadiene, isoprene, and chloroprene, as monomers.

The adhesion-promoting monomers include not only compounds which have an acetoacetoxy unit attached covalently to the double-bond system but also compounds containing covalently bonded urea groups. The first-mentioned compounds include, in particular, acetoacetoxyethyl (meth)acrylate and allyl acetoacetate. The compounds containing urea groups include, for example, N-vinylurea and N-allylurea, and also derivatives of imidazolidin-2-one, such as N-vinyl- and N-allyl-imidazolidin-2-one, N-vinyloxyethylimidazolidin-2-one, N-(2-(meth)acrylamidoethyl)imidazolid-2-one, N-(2-(meth)acryloyloxyethyl)imidazolidin-2-one, N-(2-(meth)acryloyloxyacetamidoethyl)imidazolidin-2-one, and further adhesion promoters known to the skilled worker and based on urea or imidazolidin-2-one. Also suitable for improving the adhesion is diacetoneacrylamide in combination with a subsequent addition of adipic dihydrazide to the dispersion.

As crosslinking monomers it is possible to use not only difunctional but also polyfunctional monomers. Examples thereof are diallyl phthalate, diallyl maleate, triallyl cyanurate, tetraallyloxyethane, divinylbenzene, butane-1,4-diol di(meth)acrylate, triethylene glycol di(meth)acrylate, divinyl adipate, allyl (meth)acrylate, vinyl crotonate, methylenebisacrylamide, hexanediol diacrylate, pentaerythritol diacrylate, and trimethylolpropane triacrylate.

The functional monomers can be used where appropriate in amounts of 0.1% to 25% by weight, preferably of 0.5% to 10% by weight, based on the total amount of the monomers. The crosslinking monomers are used where appropriate in amounts of 0.02% to 5% by weight, preferably of,0.02% to 1 % by weight, based on the total amount of the monomers.

When selecting the appropriate monomers or monomer combinations it is necessary to take account of the generally acknowledged prospects relating to the preparation of dispersions that are used for preparing adhesives. Thus it is necessary in particular to ensure that polymers are formed which, under the envisaged drying conditions for the coating, form an adhesive film, and that the selection of the monomers for preparing copolymers is made such that the formation of copolymers is likely in view of the position of the polymerization parameters.

Preference is given to using polymer dispersions derived from acrylates, methacrylates and/or vinyl esters of aliphatic carboxylic acids.

Preferred monomer mixtures of the monomers for preparing poly(meth)acrylates, together where appropriate with vinyl esters, are vinyl acetate/butyl acrylate, vinyl acetate/dibutyl maleate, vinyl acetate/dibutyl fumarate, vinyl acetate/2-ethylhexyl acrylate, vinyl acetate/ethene/butyl acrylate, vinyl acetate/ethene/dibutyl maleate, vinyl acetate/ethene/dibutyl fumarate, vinyl acetate/ethene/2-ethylhexyl acrylate, methyl methacrylate/butyl acrylate, methyl methacrylate/2-ethylhexyl acrylate, styrene/butyl acrylate, styrene/2-ethylhexyl acrylate, methyl methacrylate/isobutyl acrylate, and methyl methacrylate/isopropyl acrylate.

Further preferred monomer mixtures of the monomers for preparing polyvinyl esters, together where appropriate with further functional monomers, are vinyl acetate/vinyl chloride/ethene, vinyl acetate/vinyl laurate/ethene, vinyl acetate/vinyl laurate/ethene/vinyl chloride, vinyl acetate/Versatic acid vinyl ester/ethene/vinyl chloride, Versatic acid vinyl ester/ethene/vinyl chloride, vinyl acetate/Versatic acid vinyl ester/ethene, and vinyl acetate/ethene, the vinyl acetate/ethene combination being particularly preferred.

The adhesive used is with particular preference a polymer dispersion prepared by free-radical emulsion polymerization which is a homopolymer or copolymer derived from acrylate and/or methacrylate as principal monomer (“polyacrylate”) or is a homopolymer or copolymer derived from vinyl ester as principal monomer (“polyvinyl ester”), preferably a polyacrylate or a polyvinyl ester having a glass transition temperature below 15° C. The glass transition temperature of the polymer can be adjusted by the skilled worker through appropriate selection of the monomer combinations.

The dispersion used in accordance with the invention is stabilized by protective colloids and/or by emulsifiers.

The protective colloids are polymeric compounds, with molecular weights for example of greater than 2000 g/mol, whereas the emulsifiers are low molecular weight compounds whose relative molecular weights, for example, are below 2000 g/mol. These compounds are added during the actual polymerization and may where appropriate also be added again after the polymerization.

Examples of protective colloids are starch, gum arabic, alginates or tragacanth, methyl-, ethyl-, hydroxyethyl- or carboxymethylcellulose, or starch modified with saturated acids or epoxides, and also synthetic substances such as polyvinyl alcohol (with or without residual acetyl content), or polyvinyl alcohol which has been partly esterified or acetalized or etherified with saturated radicals, and also polypeptides, such as gelatin, but also polyvinylpyrrolidone, polyvinylmethylacetamide or poly(meth)acrylic acid. Polyvinyl alcohol is preferred.

The weight fraction of such protective colloids when present, based on the total amount of the monomers used for the preparation, is usually up to 15%.

Additionally it may in many cases be advantageous to use nonionic and/or ionic emulsifiers during the preparation of the dispersions, in addition to or instead of the protective colloids.

Suitable nonionic emulsifiers are araliphatic and aliphatic nonionic emulsifiers, such as ethoxylated mono-, di-, and trialkylphenols (EO degree: 3 to 50, alkyl radical: C₄to C₉), ethoxylates of long-chain alcohols (EO degree: 3 to 50, alkyl radical: C₈to C₃₆), and also polyethylene oxide/polypropylene oxide block copolymers. Preference is given to using ethoxylates of long-chain alkanols (alkyl radical: C₁₀ to C₂₂, average degree of ethoxylation: 3 to 50) and, of these, particular preference to those based on naturally occurring alcohols, Guerbet alcohols or oxo-processed alcohols having a linear or branched C₁₂-C₁₈ alkyl radical and a degree of ethoxylation of 8 to 50.

Further suitable emulsifiers are found in Houben-Weyl, Methoden der organischen Chemie [Methods of organic chemistry], Volume XIV/1, Macromolekulare Stoffe [Macromolecular compounds], Georg-Thieme-Verlag, Stuttgart, 1961, pp. 192-208).

Suitable ionic emulsifiers include both anionic and cationic emulsifiers.

The anionic emulsifiers include alkali metal salts and ammonium salts of alkyl sulfates (alkyl radical: C₈to C₁₈), alkylphosphonates (alkyl radical: C₈to C₁₈), of sulfuric monoesters or phosphoric monoesters and diesters with ethoxylated alkanols (EO degree: 2 to 50, alkyl radical: C₈ to C₂₂) and with ethoxylated alkylphenols (EO degree: 3 to 50, alkyl radical: C₄ to C₉), of alkylsulfonic acids (alkyl radical: C₁₂ to C₁₈), of alkylarylsulfonic acids (alkyl radical: C₉to C₁₈), of sulfosuccinic monoesters and sulfosuccinic diesters of alkanols (alkyl radical: C₈ to C₂₂) and ethoxylated alkanols (EO degree: 2 to 50, alkyl radical: C₈ to C₂₂), and also with nonethoxylated and ethoxylated alkylphenols (EO degree: 3 to 50, alkyl radical: C₄ to C₉). In general the emulsifiers listed are used as technical mixtures, the statements of alkyl radical length and EO chain length referring to the respective maximum of the distributions which occur within the mixtures. Examples from the stated classes of emulsifier are ®Texapon K12 (sodium lauryl sulfate from Cognis), ®Emulsogen EP (C₁₃-C₁₇ alkylsulfonate from Clariant), ®Maranil A 25 IS (sodium n-alkyl(C₁₀-C₁₃)-benzenesulfonate from Cognis), ®Genapol liquid ZRO (sodium C₁₂/C₁₄ alkyl ether sulfate with 3 EO units, from Clariant), ®Hostapal BVQ4 (sodium salt of a nonyl-phenol ether sulfate with 4 EO units, from Clariant), Aerosol MA 80 (sodium dihexylsulfosuccinate from Cytec Industries), Aerosol A-268 (disodium isodecylsulfosuccinate from Cytec Industries), and Aerosol A-103 (disodium salt of a monoester of sulfosuccinic acid with an ethoxylated nonylphenol, from Cytec Industries).

The cationic emulsifiers include, for example, alkylammonium acetates (alkyl radical: C₈to C₁₂), quaternary compounds containing ammonium groups, and pyridinium compounds.

With regard to the choice of the ionic emulsifiers it must of course be ensured that incompatibilities in the resultant polymer dispersion, which could lead to coagulation, are ruled out. It is therefore preferred to use anionic emulsifiers in combination with anionic monomers or to use cationic emulsifiers in combination with cationic monomers, the combinations of anionic emulsifiers and anionic monomers being particularly preferred.

The amounts of the emulsifiers, where used, are within the normally observable limits. Overall, therefore, up to about 10% by weight, preferably up to 5% by weight, based on the total amount of the monomers employed for preparing the dispersions, is used. In general, mixtures of ionic and nonionic emulsifiers are employed, though it is also possible to use ionic and nonionic emulsifiers alone in order to stabilize the dispersions additionally.

The aqueous polymer dispersions used in accordance with the invention typically possess solids contents of 20% to 70%, preferably 30% to 65%, and more preferably 40% to 60% by weight.

The polymer dispersions used in accordance with the invention further comprise, if desired, additional adjuvants that are customary per se.

Additives and further constituents that can be used include film-forming assistants, such as white spirit, Texanol®, TxiB®, butyl glycol, butyl diglycol, butyldipropylene glycol, and butyltripropylene glycol; plasticizers, such as dimethyl phthalate, diisobutyl phthalate, diisobutyl adipate, Coasol B®, and Plastilit 3060®; wetting agents, such as AMP 90®, TegoWet.280®, Fluowet PE®; thickeners, such as polyacrylates or polyurethanes, such as Borchigel L75® and Tafigel PUR 60®; defoamers, examples being mineral oil defoamers or silicone defoamers; UV stabilizers, such as Tinuvin 1130®, retro-added stabilizing emulsifiers or polymers, such as polyvinyl alcohol or cellulose ethers, rheology modifiers, examples being polyacrylate or polyurethane thickeners, and other additives and auxiliaries such as are customary in the formulation of adhesives.

The minimum film-forming temperature of the adhesives used in accordance with the invention is typically below 25° C., preferably below 15° C. The film-forming temperature can be modified and tailored by adding conventional coalescents.

The polymer dispersion employed in accordance with the invention is prepared by free-radical emulsion polymerization. This can be carried out by a batch process, a feed process, a combined batch/feed process, or a continuous process.

Preference, however, is given to operating in a combined batch/feed process or, with particular preference, in a feed process, in which usually a portion of the monomers (1% to 15% by weight) is introduced initially in order to start the polymerization. The metering of the monomers may take place either together or in separate feeds. Additionally it may be advantageous in certain embodiments to carry out a seed polymerization in order to set specific particle sizes and particle-size distributions.

Examples of free-radical initiators used include the following: hydrogen peroxide, benzoyl peroxide, cyclohexanone peroxide, isopropyl cumyl hydroperoxide, persulfates of potassium, of sodium, and of ammonium, peroxides of even-numbered saturated monovalent aliphatic carboxylic acids with a chain length of C₈-C₁₂, tertiary-butyl hydroperoxide, ditertiary-butyl peroxide, diisopropyl percarbonate, azoisobutyrodinitrile, acetyl cyclohexanesulfonyl peroxide, tertiary-butyl perbenzoate, tertiary-butyl peroctoate, bis-3,5,5-trimethylhexanoyl peroxide, tertiary-butyl perpivalate, hydroperoxypinane, and p-menthane hydroperoxide. The aforementioned compounds may also be used as part of a redox system including transition metal salts such as iron(II) salts or other reducing agents. As reducing agents or regulators it is possible to use alkali metal salts of oxymethanesulfinic acid, mercaptans of C₁₀-C₁₄ chain length, but-1 -en-3-ol, hydroxylamine salts, sodium dialkyldithiocarbamate, sodium bisulfite, ammonium bisulfite, sodium dithionite, diisopropylxanthogen disulfide, ascorbic acid, tartaric acid, isoascorbic acid, boric acid, urea, and formic acid.

However, it is preferred to use water-soluble persulfates, especially ammonium persulfate or sodium persulfate, to initiate the polymerization.

Emulsifier and/or protective colloid used for stabilization may likewise be added alternatively in its entirety at the beginning of the polymerization, included in-the initial charge, or part included in the initial charge and part metered in, or metered in in its entirety during the polymerization.

The pH of the dispersion is typically between 2 and 7, preferably between 2.5 and 6.

The polymerization temperature is typically within the range from 20 to 120° C., preferably in the range from 30 to 110° C., and very preferably in the range from 45 to 95° C.

After the end of the polymerization it is possible, for the purpose of demonomerization, to add on a further, preferably chemical, aftertreatment, in particular using redox catalysts, such as combinations of the abovementioned oxidizing agents and reducing agents, for example. Furthermore, it is possible to remove residual monomer that is present by a known means, such as by physical demonomerization, i.e., distillative removal (in particular via steam distillation) or by stripping with an inert gas. A combination of physical and chemical methods is particularly efficient and allows a reduction in residual monomers to very low levels (<1000 ppm, preferably <100 ppm).

The amount of the polymer in the adhesive used in accordance with the invention is typically 50% to 99.9% by weight, preferably 80 to 99.8% by weight, based on the solids content of the adhesive.

The adhesive employed in accordance with the invention comprises at least one organosilane. Said silane may be present during the actual preparation of the polymer dispersion and/or may be added subsequently. The amount of organosilane compound is typically 0.05% to 20% by weight, preferably 0.05% to 5% by weight, based on the solids content of the adhesive.

It is possible to use any organosilanes which in addition to at least one silane group have at least one primary, secondary or tertiary amino group or at least one epoxide group or which comprise ethylenically unsaturated groups and silane groups. Possible compounds are both those which are incorporated into the polymer during the polymerization and those which are present alongside the polymer as a separate component in the dispersion.

The organosilanes used in accordance with the invention include preferably compounds of the formula I or II
a) an organofunctional silane 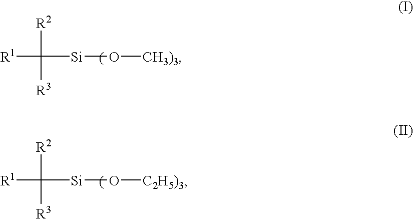
   in which R¹ is —(CH₂)ₙ—NH—R⁴, —(CH₂)ₙ—NH—[(CH₂)ₘ—NH]ₒ—R⁴, —(CH₂)ₙ—O—R⁵ or —(CH₂)₁—CH═CH₂,

R² is hydrogen, —(CH₂)ₙ—CH₃ or R¹,

R³ is hydrogen, —(CH₂)ₙ—CH₃ or R²,

R⁴ is hydrogen, —(CH₂)ₙ—CH₃ or —CO—(CH₂)ₘ—CH₃, and

R⁵ is hydrogen, —(CH₂—CH₂—O)ₘ—R⁴ or

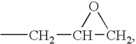

n and m each independently of one another being an integer between 0 and 12, and o being an integer between 0 and 5.

Further silanes employed with preference are polyfunctional silanes. They include, in particular, compounds which in addition to at least one silane group have at least one primary, secondary or tertiary amino group or at least one epoxide group, or polyfunctional silanes containing two or more ethylenically unsaturated groups in the molecule.

Particularly preferred compounds from this group are compounds of the formulae III, IV, V or VI
(R⁶—O)₃—Si—(CH₂)ₚ—NH—(CH₂)ₚ—Si—(O—R⁶)₃ (III),
(R⁶—O)₃—Si—(CH₂)ₚ—N[—(CH₂)ₚ—Si—(O—R⁶]₂ (IV),
(R⁶—O)₃—Si—(CH₂)ₚ—O—R⁷ (V),
(R⁶—O)₃—Si—(CH₂)ₚ—NR⁸R⁹ (VI),

in which R⁶ independently at each occurrence is hydrogen or C₁-C₆ alkyl, preferably methyl, ethyl or propyl,

R⁷ is a glycidyl radical (1,2-epoxypropyl),

R⁸ and R⁹ independently of one another are hydrogen or C₁-C₆ alkyl, and

p is an integer between 1 and 12.

Particularly preferred silanes of the formulae III and IV are the following compounds:
(CH₃—CH₂—O)₃—Si—(CH₂)ₚ—NH—(CH₂)ₚ—Si—(O—CH₂—CH₃)₃,
(CH₃—O)₃—Si—(CH₂)ₚ—NH—(CH₂)ₚ—Si—(O—CH₃)₃,
(CH₃—CH₂—O)₃—Si—(CH₂)ₚ—N[—(CH₂)ₚ—Si—(O—CH₂—CH₃)₃]₂,
(CH₃—O)₃—Si—(CH₂)ₚ—N[—(CH₂)ₚ—Si—(O—CH₃)₃]₂

in which p is as defined above.

The silanes can be used as individual compounds or as mixtures.

Examples that may be mentioned of silane compounds of the aforementioned types that are available commercially include the following: Silanes of the trade name Dynasylan® (Degussa), of the trade names ADDID® or Geniosil® (Wacker), or of the trade name Silquest® (Crompton).

Organosilanes which are incorporated into the polymer include ethylenically unsaturated monomers which contain silane groups and are of the formula R¹¹Si(CH₃)₀₋₂(OR¹²)₃₋₁, where R¹¹ has the definition CH₂═CR¹³—(CH₂)₀₋₁ CH₂═CR¹³CO₂—(CH₂)₁₋₃, R¹² is an unbranched or branched, unsubstituted or substituted alkyl radical having 1 to 12 carbon atoms and may be uninterrupted or interrupted by an ether group, and R¹³ is hydrogen or methyl.

Preferred silanes are of the formulae CH₂═CR¹³—(CH₂)₀₋₁Si(CH₃)₀₋₁(OR¹²)₃₋₂ and CH₂═CR¹³CO₂—(CH₂)₃Si(CH₃)₀₋₁ (OR¹²)₃₋₂, where R¹² is an unbranched or branched, unsubstituted or substituted alkyl radical having 1 to 12 carbon atoms and R¹³ is hydrogen or methyl.

Particularly preferred silanes are vinylmethyldimethoxysilane, vinylmethyldiethoxysilane, vinylmethyldi-n-propoxysilane, vinylmethyldiisopropoxysilane, vinylmethyldi-n-butoxysilane, vinylmethyldi-sec-butoxysilane, vinylmethyldi-tert-butoxysilane, vinylmethyldi(2-methoxyisopropyloxy)silane, and vinylmethyldioctyloxysilane.

Especially preferred silanes are of the formula CH₂═CR¹³—(CH₂)₀₋₁Si(OR¹⁴)₃ and CH₂═CR¹³CO₂—(CH₂)₃Si(OR¹⁴)₃, where R¹⁴ is a branched or unbranched alkyl radical having 1 to 4 carbon atoms and R¹³ is hydrogen or methyl.

Examples thereof are γ-(meth)acryloyloxypropyltris(2-methoxyethoxy)silane, γ-(meth)acryloyloxypropyltrismethoxysilane, γ-(meth)acryloyloxypropyltrisethoxysilane, γ-(meth)acryloyloxypropyltris-n-propoxysilane, γ-(meth)acryloyloxypropyltrisisopropoxysilane, γ-(meth)acryloyloxypropyltrisbutoxysilane, γ-acryloyloxypropyltris(2-methoxyethoxy)silane, γ-acryloyloxypropyltrismethoxysilane, γ-acryloyloxypropyltrisethoxysilane, γ-acryloyloxypropyltris-n-propoxysilane, γ-acryloyloxypropyltrisisopropoxysilane, γ-acryloyloxypropyltrisbutoxysilane, and vinyltris(2-methoxyethoxy)silane, vinyltrismethoxysilane, vinyltrisethoxysilane, vinyltris-n-propoxysilane, vinyltrisisopropoxysilane, and vinyltrisbutoxysilane. The stated silane compounds may where appropriate also be used in the form of their (partial) hydrolysates.

Silanes employed with particular preference are primary and secondary aminoalkylethoxysilanes, bis(3-triethoxysilylpropyl)amine, trifunctional propyltrimethoxysilane [NH₂—(CH₂)₂—NH—(CH₂)₂—NH—(CH₂)₃—Si(OCH₃)₃], vinyltriethoxysilane [CH₂═CH—Si(OC₂H₅)₃], vinyltrimethoxysilane [CH₂═CH—Si(OCH₃)₃], 3-glycidyloxypropyltriethoxysilane, 3-aminopropyltrimethoxysilane, oligomeric diaminosilane system, glycidyl-trimethoxy-functional silane, vinyl-triethoxy-functional silane, glycidyl-triethoxy-functional silane, vinyltris(2-methoxyethoxy)silane, (3-glycidyloxypropyl)trimethoxysilane, N-(2-aminoethyl)(3-aminopropyl)trimethoxysilane, (3-aminopropyl)triethoxysilane, N-(2-aminoethyl)(3-aminopropyl)methyldimethoxysilane, (3-aminopropyl)trimethoxysilane, (methacryloyloxymethyl)methyldimethoxysilane, (methacryloyloxymethyl)trimethoxysilane and/or (methacryloyloxymethyl)methyldiethoxysilane.

In the adhesive used in accordance with the invention the organosilane is present typically in an amount of 0.001% to 20% by weight, based on the solids content of the adhesive. Preferably the organosilane is used in an amount of 0.001% to 10% by weight.

Silane compounds are, as is known, also used to promote adhesion. Promoting adhesion, however, does not necessarily lead to an improvement in embossing strength in connection with the production of laminates.

For improved compatibility between polymer dispersion and silane compound it may be necessary to stabilize the polymer dispersion by adding surfactants or protective colloid before the addition of the organofunctional silane.

The invention also provides a process for producing the laminate described above, comprising the actions of
i) coating at least one absorbent surface of a substrate with an adhesive which comprises a polymer dispersion prepared by free-radical emulsion polymerization and an organosilane which is incorporated into the polymer during the polymerization and/or is added subsequently and which in addition to at least one silane group has at least one primary, secondary or tertiary amino group or at least one epoxide group or which comprises at least one ethylenically unsaturated group and at least one silane group,
ii) laminating a film to the adhesive-coated surface in a conventional manner, and
iii) if desired, embossing the laminate on the film-laminated side.

The laminates of the invention can be used, for example, for producing packaging cartons and other packing materials, book spines, brochures, advertising media, postcards, training boards, and also identity cards and chip cards. These uses are likewise provided by the present invention.

Additionally provided by the present invention is the use of adhesives comprising an organosilane and a polymer dispersion prepared by free-radical emulsion polymerization for bonding polymeric films to porous substrates and for high gloss film lamination.

The examples which follow elucidate the invention without restricting it.

### EXAMPLE 1

An aqueous dispersion of an acrylate copolymer based on methyl methacrylate and 2-ethylhexyl acrylate, with the glass transition temperature, T_{g}, of −18° C., was admixed with 0.5% of an emulsifier (Emulsogen EPN 287) and 0.5% of an aminosilane (N-(2-aminoethyl)(3-aminopropyl)trimethoxysilane). The initial dispersion and the mixture were each adjusted, following dilution with water, to a viscosity of approximately 100 mPa*s (Brookfield RVT, Spindle 1/20 rpm, 23° C.) and used to laminate an OPP film (20 μm thick, corona-pretreated on one side; Trespaphan NND 20) to a paper sheet (100 g/m²) printed in deep black.

Lamination was carried out on a laminating unit in which the adhesive was applied by airbrush to the pretreated side of the OPP film. Following application of adhesive, the film passed through a drying tunnel operated at a temperature of 60-70° C. The lamination of film and print support was carried out with heat activation after passage through the drying tunnel, between a silicone roll and a roll heated to 80° C.

On one portion of the laminated specimens, measurements were made of the peel strength and the heat stability at 80° C., in direct comparison. The results for the peel strength were reported for different peel rates, as averages of three measurements in each case, in N/2.5 cm. The results for the heat stability are reported as the time after which a peel length of 5 cm was reached at 80° C. on a sample 2.5 cm wide sample under a load of 100 g or of 200 g. Here again, the figure reported was the average of three individual measurements.

A second portion of the laminated specimens was subjected to an embossing test (linen pattern), 24 h after lamination, in a roller embossing unit, the pressure being set at a level such that there was just no raising of the paper fiber at the embossed edges. An assessment was made of whether, 24 h following embossing, there were signs of delamination visible—gray coloration, for example. These tests were always carried out in direct comparison.

TABLE 1
Results of the laminating tests

| | | | | | | | Heat stability | | |
|---|---|---|---|---|---|---|---|---|---|
| | | Peel strength of the laminates | | | | | at 80° C. in | | |
| Laminating | Adhesive | in N/2.5 cm at a peel rate of | | | | | minutes | | |
| adhesive | application | 5 | 10 | 20 | 40 | 60 | 100 g/ | 200 g/ | Assessment |
| used | rate (g/m²) | cm/min | cm/min | cm/min | cm/min | cm/min | 2.5 cm | 2.5 cm | of embossing |
| without silane | 9.4 | 2.1 | 2.2 | 2.4 | 2.8 | 2.9 | 1:47 | 0:11 | distinct |
| | | | | | | | | | delamination |
| with silane | 8.3 | 2.4 | 2.4 | 2.7 | 2.9 | 3.2 | 2:27 | 0:19 | slight |
| | | | | | | | | | delamination |

### EXAMPLE 2

An aqueous dispersion of an acrylate copolymer based on methyl methacrylate and 2-ethylhexyl acrylate, with the glass transition temperature, T_{g}, of −18° C., was admixed with 1% of an epoxysilane (gamma-glycidyloxypropyltrimethoxysilane). The initial dispersion and the mixture were each adjusted, following dilution with water, to a viscosity of approximately 100 mPa*s (Brookfield RVT, Spindle 1/20 rpm, 23° C.) and used to laminate an OPP film (20 μm thick, corona-pretreated on one side; Trespaphan NND 20) to a paper sheet (100 g/m²) printed in deep black.

Lamination and the measurement of the properties of the laminated specimens were carried out in the same way as for example 1. The results are collated in table 2.

TABLE 2
Results of the laminating tests

| | | | | | | | Heat stability | | |
|---|---|---|---|---|---|---|---|---|---|
| | | Peel strength of the laminates | | | | | at 80° C. in | | |
| Laminating | Adhesive | in N/2.5 cm at a peel rate of | | | | | minutes | | |
| adhesive | application | 5 | 10 | 20 | 40 | 60 | 100 g/ | 200 g/ | Assessment |
| used | rate (g/m²) | cm/min | cm/min | cm/min | cm/min | cm/min | 2.5 cm | 2.5 cm | of embossing |
| without silane | 9.4 | 2.1 | 2.2 | 2.4 | 2.8 | 2.9 | 1:47 | 0:11 | distinct |
| | | | | | | | | | delamination |
| with silane | 10.2 | 2.7 | 2.6 | 2.7 | 2.9 | 3.1 | 3:24 | 0:38 | virtually no |
| | | | | | | | | | delamination |

### EXAMPLE 3

An aqueous dispersion of an acrylate copolymer based on methyl methacrylate and butyl acrylate, with the glass transition temperature, T_{g}, of −20° C., was admixed with 0.5% of an epoxysilane (gamma-glycidyloxypropyltrimethoxysilane). The initial dispersion and the mixture were each adjusted, following dilution with water, to a viscosity of approximately 100 mPa*s (Brookfield RVT, Spindle 1/20 rpm, 23° C.) and used to laminate an OPP film (20 μm thick, corona-pretreated on one side; Trespaphan NND 20) to a paper sheet (100 g/m²) printed in deep black.

Lamination and the measurement of the properties of the laminated specimens were carried out in the same way as for example 1. The results are collated in table 3.

TABLE 3
Results of the laminating tests

| | | | | | | | Heat stability | | |
|---|---|---|---|---|---|---|---|---|---|
| | | Peel strength of the laminates | | | | | at 80° C. in | | |
| Laminating | Adhesive | in N/2.5 cm at a peel rate of | | | | | minutes | | |
| adhesive | application | 5 | 10 | 20 | 40 | 60 | 100 g/ | 200 g/ | Assessment |
| used | rate (g/m²) | cm/min | cm/min | cm/min | cm/min | cm/min | 2.5 cm | 2.5 cm | of embossing |
| without silane | 10.2 | 3.7 | 3.5 | 3.7 | 4.3 | 4.6 | 20:34 | 1:08 | visible |
| | | | | | | | | | delamination |
| with silane | 10.3 | 3.3 | 3.3 | 3.3 | 4.2 | 4.0 | 4:14 | 0:24 | no |
| | | | | | | | | | delamination |

### EXAMPLE 4

An aqueous dispersion of an acrylate copolymer based on methyl methacrylate and butyl acrylate (Acronal® A 310) was admixed with 1% of an epoxysilane (gamma-glycidyloxypropyltrimethoxysilane). The initial dispersion and the mixture were each adjusted, following dilution with water, to a viscosity of approximately 100 mPa*s (Brookfield RVT, Spindle 1/20 rpm, 23° C.) and used to laminate an OPP film (20 μm thick, corona-pretreated on one side; Trespaphan NND 20) to a paper sheet (100 g/m²) printed in deep black.

Lamination and the measurement of the properties of the laminated specimens were carried out in the same way as for example 1. The results are collated in table 4.

TABLE 4
Results of the laminating tests

| | | | | | | | Heat stability | | |
|---|---|---|---|---|---|---|---|---|---|
| | | Peel strength of the laminates | | | | | at 80° C. in | | |
| Laminating | Adhesive | in N/2.5 cm at a peel rate of | | | | | minutes | | |
| adhesive | application | 5 | 10 | 20 | 40 | 60 | 100 g/ | 200 g/ | Assessment |
| used | rate (g/m²) | cm/min | cm/min | cm/min | cm/min | cm/min | 2.5 cm | 2.5 cm | of embossing |
| without silane | 10.4 | 4.6 | 4.6 | 4.9 | 5.5 | 6.3 | 15:22 | 1:42 | visible |
| | | | | | | | | | delamination |
| with silane | 10.3 | 3.5 | 3.5 | 3.4 | 4.2 | 4.6 | 8:00 | 1:09 | no |
| | | | | | | | | | delamination |

### EXAMPLE 5

An anionically stabilized, finely divided copolymer dispersion with 25% methyl methacrylate and 75% butyl acrylate as principal monomers (solids content: 50.5%, pH: 8.2, T_{g}: −21° C., particle-size distribution: Mastersizer, multimodal Mie evaluation: dₙ=220 nm, d_{w}=260 nm) was admixed with 1% of aminosilane (N-(2-aminoethyl)(3-aminopropyl)trimethoxysilane). The initial dispersion and the mixture were each adjusted, following dilution with water, to a viscosity of approximately 100 mPa*s (Brookfield RVT, Spindle-1/20 rpm, 23° C.) and used to laminate an OPP film (20 μm thick, corona-pretreated on one side; Trespaphan NND 20) to a paper sheet (100 g/m²) printed in deep black.

Lamination and the measurement of the properties of the laminated specimens were carried out in the same way as for example 1. The results are collated in table 5.

TABLE 5
Results of the laminating tests

| | | | | | | | Heat stability | | |
|---|---|---|---|---|---|---|---|---|---|
| | | Peel strength of the laminates | | | | | at 80° C. in | | |
| Laminating | Adhesive | in N/2.5 cm at a peel rate of | | | | | minutes | | |
| adhesive | application | 5 | 10 | 20 | 40 | 60 | 100 g/ | 200 g/ | Assessment |
| used | rate (g/m²) | cm/min | cm/min | cm/min | cm/min | cm/min | 2.5 cm | 2.5 cm | of embossing |
| without silane | 9.5 | 2.4 | 2.5 | 2.7 | 3.0 | 3.2 | 1:35 | 0:10 | distinct |
| | | | | | | | | | delamination |
| with silane | 10.2 | 3.0 | 2.6 | 2.7 | 3.2 | 3.6 | 5:35 | 0:17 | virtually no |
| | | | | | | | | | delamination |

### EXAMPLE 6

An anionically stabilized, finely divided copolymer dispersion with 30% methyl methacrylate and 70% 2-ethylhexyl acrylate as principal monomers (solids content: 52.3%, pH: 8.0, T_{g}: −18° C., particle-size distribution: Mastersizer, multimodal Mie evaluation: dₙ=190 nm, d_{w}=200 nm) was admixed with 1% of epoxysilane (gamma-glycidyloxypropyltrimethoxysilane). The initial dispersion and the mixture were each adjusted, following dilution with water, to a viscosity of approximately 100 mPa*s (Brookfield RVT, Spindle 1/20 rpm, 23° C.) and used to laminate an OPP film (20 μm thick, corona-pretreated on one side; Trespaphan NND 20) to a paper sheet (100 g/m²) printed in deep black.

Lamination and the measurement of the properties of the laminated specimens were carried out in the same way as for example 1. The results are collated in table 6.

TABLE 6
Results of the laminating tests

| | | | | | | | Heat stability | | |
|---|---|---|---|---|---|---|---|---|---|
| | | Peel strength of the laminates | | | | | at 80° C. in | | |
| Laminating | Adhesive | in N/2.5 cm at a peel rate of | | | | | minutes | | |
| adhesive | application | 5 | 10 | 20 | 40 | 60 | 100 g/ | 200 g/ | Assessment |
| used | rate (g/m²) | cm/min | cm/min | cm/min | cm/min | cm/min | 2.5 cm | 2.5 cm | of embossing |
| without silane | 10.7 | 2.9 | 3.1 | 3.4 | 3.7 | 3.9 | 18:38 | 1:00 | visible |
| | | | | | | | | | delamination |
| with silane | 9.5 | 3.3 | 3.2 | 4.1 | 3.4 | 3.9 | 3:51 | 0:29 | no |
| | | | | | | | | | delamination |

1. An embossable laminate comprising
a) a sheetlike substrate having at least one absorbent surface,
b) a film and
c) an adhesives; wherein the film is joined to the substrate by means of said adhesive which comprises a polymer dispersion prepared by free-radical emulsion polymerization and an organosilane comprising at least one silane group and at least one primar, secondary or tertiary amino group, at least one epoxide group, or at least one ethvlenically unsaturated group and one silane group, and
wherein the organosilane is incorporated into the polymer during the polymerization or is added subsequently.

2. The laminate as claimed in claim 1, wherein said substrate is selected from the group consisting of papers, cards, cardboards, and other fiber webs.

3. The laminate as claimed in claim 2, wherein the substrate is printed and/or coated.

4. The laminate as claimed in claim 1, wherein the film is selected from the group consisting of metal foils and polymeric films.

5. The laminate as claimed in claim 1, wherein the substrate is printed and wherein the film is polymeric and light-transmissive.

6. The laminate as claimed in claim 1, wherein the polymer dispersion is a polyacrylate or a polyvinyl ester.

7. The laminate as claimed in claim 1, wherein the polymer dispersion is derived from vinyl acetate/butyl acrylate, vinyl acetate/dibutyl maleate, vinyl acetate/dibutyl fumarate, vinyl acetate/2-ethylhexyl acrylate, vinyl acetate/ethene/butyl acrylate, vinyl acetate/ethene/dibutyl maleate, vinyl acetate/ethene/dibutyl fumarate, vinyl acetate/ethene/2-ethylhexyl acrylate, methyl methacrylate/butyl acrylate, methyl methacrylate/2-ethylhexyl acrylate, styrene/butyl acrylate, styrene/2-ethylhexyl acrylate, methyl methacrylate/isobutyl acrylate or methyl methacrylate/isopropyl acrylate.

8. The laminate as claimed in claim 1, wherein the polymer dispersion is derived from the principal monomers vinyl acetate/vinyl chloride/ethene, vinyl acetate/vinyl laurate/ethene, vinyl acetate/vinyl laurate/ethene/vinyl chloride, vinyl acetatenersatic acid vinyl ester/ethene/vinyl chloride, Versatic acid vinyl ester/ethene/vinyl chloride, vinyl acetatenersatic acid vinyl ester/ethene, and vinyl acetate/ethane

9. The laminate as claimed in claim 1, wherein said organosilane is a compound of the formula I or II 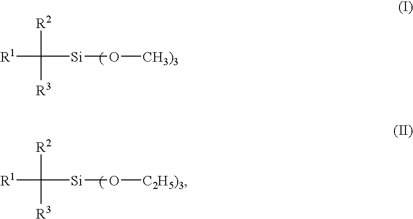
in which R¹ is —(CH₂)ₙ—NH—R⁴, —(CH₂)ₙ—NH—[(CH₂)ₘ—NH]ₒ—R⁴, —(CH₂)ₙ—O—R⁵ or —(CH₂)₁—CH═CH₂,
R² is hydrogen, —(CH₂)ₙ—CH₃ or R¹,
R³is hydrogen, —(CH₂)ₙ—CH₃ or R²,
R⁴ is hydrogen, —(CH₂)ₙ—CH₃ or —CO—(CH₂)ₘ—CH₃, and
R⁵is hydrogen, —(CH₂—CH₂—O)ₘ—R⁴ or 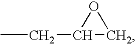
n and m each independently of one another being an integer between 0 and 12, and o being an integer between 0 and 5.

10. The laminate as claimed in claim 1, wherein said organosilane is a compound comprising at least one silane group, at least one primary, secondary or tertiary amino group, or at least one epoxide group.

11. The laminate as claimed in claim 10, wherein said organosilane is a compound of the formula III, IV, V or VI
(R⁶—O)₃—Si—(CH₂)ₚ—NH—(CH₂)ₚ—Si—(O—R⁶)₃ (III),
(R⁶—O)₃—Si—(CH₂)ₚ—N[—(CH₂)ₚ—Si—(O—R⁶]₂ (IV),
(R⁶—O)₃—Si—(CH₂)ₚ—O—R⁷ (V),
(R⁶—O)₃—Si—(CH₂)ₚ—NR⁸R⁹ (V),
in which R⁶ independently at each occurrence is hydrogen or C₁-C₆ alkyl,
R⁷ is a glycidyl radical,
R⁸ and R⁹ independently of one another are hydrogen or C₁-C₆ alkyl, and
p is an integer between 1 and 12.

12. The laminate as claimed in claim 11, wherein said organosilane is a compound of the formula
(CH₃—CH₂—O)₃—Si—(CH₂)ₚ—NH—(CH₂)ₚ—Si—(O—CH₂—CH₃)₃,
(CH₃—O)₃—Si—(CH₂)ₚ—NH—(CH₂)ₚ—Si—(O—CH₃)₃,
(CH₃—CH₂—O)₃—Si—(CH₂)ₚ—N[—(CH₂)ₚ—Si—(O—CH₂—CH₃)₃]₂
(CH₃—O)₃—Si—(CH₂)ₚ—N[—(CH₂)ₚ—Si—(O—CH₃)₃]₂
in which p is an integer between 1 and 12.

13. The laminate as claimed in claim 1, wherein said organosilane is an ethylenically unsaturated compound containing silane groups and is of the formula R¹¹Si(CH₃)₀₋₂(OR¹²)₃₋₁, where R¹¹ is CH₂═CR¹³—(CH₂)₀₋₁ or CH₂═CR¹³CO₂—(CH₂)₁₋₃, R¹² is an unbranched or branched, unsubstituted or substituted alkyl radical having 1 to 12 carbon atoms and is uninterrupted or interrupted by an ether group, and R¹³ is hydrogen or methyl.

14. The laminate as claimed in claim 1, wherein said organosilane is an ethylenically unsaturated compound containing silane groups and is of the formula CH₂═CR¹³—(CH₂)₀₋₁Si(CH₃)₀₋₁(OR¹²)₃₋₂ or CH₂═CR¹³CO₂—(CH₃)₀₋₁(OR¹²)₃₋₂, where R¹² is an unbranched or branched, unsubstituted or substituted alkyl radical having 1 to 12 carbon atoms and R¹³ is hydrogen or methyl.

15. The laminate as claimed in claim 14, wherein said organosilane is a compound selected from the group consisting of vinylmethyldimethoxysilane, vinylmethyldiethoxysilane, vinylmethyldi-n-propoxysilane, vinylmethyldiisopropoxysilane, vinylmethyldi-n-butoxysilane, vinylmethyldi-sec-butoxysilane, vinylmethyldi-tert-butoxysilane, vinylmethyldi(2-methoxyisopropyloxy)silane and vinylmethyldioctyloxysilane.

16. The laminate as claimed in claim 14, wherein said organosilane is a compound of the formula CH₂═CR¹³—(CH₂)₀₋₁Si(OR¹⁴)₃ or CH₂═CR¹³CO₂—(CH₂)₃Si(OR¹⁴)₃, where R¹⁴ is a branched or unbranched alkyl radical having 1 to 4 carbon atoms and R¹³ is hydrogen or methyl.

17. The laminate as claimed in claim 16, wherein said organosilane is a compound selected from the group consisting of γ-(meth)acryloyloxypropyltris-(2-methoxyethoxy)silane, γ-(meth)acryloyloxypropyltrismethoxysilane, γ-(meth)acryloyloxypropyltrisethoxysilane, γ-(meth)acryloyloxypropyltris-n-propoxysilane, γ-(meth)acryloyloxypropyltrisisopropoxysilane, γ-(meth)acryloyloxypropyltrisbutoxysilane, γ-acryloyloxypropyltris(2-methoxyethoxy)silane, γ-acryloyloxypropyltrismethoxysilane, γ-acryloyloxypropyltrisethoxysilane, γ-acryloyloxypropyltris-n-propoxysilane, γ-acryloyloxypropyltrisisopropoxysilane, γ-acryloyloxypropyltrisbutoxysilane, and vinyltris(2-methoxyethoxy)silane, vinyltrismethoxysilane, vinyltrisethoxysilane, vinyltris-n-propoxysilane, vinyltrisisopropoxysilane and vinyltrisbutoxysilane.

18. The laminate as claimed in claim 1, wherein the organosilane is a compound selected from the group consisting of primary and secondary aminoalkylethoxysilanes, bis(3-triethoxysilylpropyl)amine, trifunctional propyltrimethoxysilane [NH₂—(CH₂)₂—NH—(CH₂)₂—NH—(CH₂)₃—Si(OCH₃)₃], vinyltriethoxysilane [CH₂═CH—Si(OC₂H₅)₃], vinyltrimethoxysilane [CH₂═CH—Si(OCH₃)₃], 3-glycidyloxypropyltriethoxysilane, 3-aminopropyltrimethoxysilane, oligomeric diaminosilane system, glycidyl-trimethoxy-functional silane, vinyl-triethoxy-functional silane, glycidyl-triethoxy-functional silane, vinyltris(2-methoxyethoxy)silane, (3-Glycidyloxypropyl)trimethoxysilane, N-(2-aminoethyl)(3-aminopropyl)trimethoxysilane, (3-aminopropyl)triethoxysilane, N-(2-aminoethyl)(3-aminopropyl)methyldimethoxysilane, (3-aminopropyl)trimethoxysilane, (methacryloyloxymethyl)methyldimethoxysilane, (methacryloyloxymethyl)trimethoxysilane and (methacryloyloxymethyl)methyldiethoxysilane.

19. The laminate as claimed in claim 1, further comprising embossing on the film side.

20. A process for producing the laminate as claimed in claim 1, comprising
i) coating at least one absorbent surface of a substrate with an adhesive which comprises a polymer dispersion prepared by free-radical emulsion polymerization and an organosilane which is incorporated into the polymer during the polymerization or is added subsequently and which comprises at least one silane group, at least one primary, secondary or tertiary amino group, at least one epoxide group, or at least one ethylenically unsaturated group and at least one silane group, and
ii) laminating a film to the adhesive-coated surface.

21. A process for producing packaging cartons, packing materials, book spines, brochures, advertising media, postcards, training boards, identity cards or chip cards which comprises employing the laminate as claimed in claim 1.

22. A process for bonding polymeric films to porous substrates or for high gloss film lamination which comprises applying to a polymeric film an adhesive comprising a polymer dispersion prepared by free-radical emulsion polymerization and an organosilane which is incorporated into the polymer during the polymerization or is added subsequently and which comprises at least one silane group, at least one primary, secondary or tertiary amino group, at least one epoxide group, or at least one ethylenically unsaturated group and at least one silane group.

23. The laminate as claimed in claim 6, wherein the polyacrylate or a polyvinyl ester has a glass transition temperature below 15° C.

24. The process of claim 20 further comprising embossing the laminate on the film-laminated side.
